(19) United States
(12) Patent Application Publication
(10) Pub. No.: US 2011/0061879 A1
(43) Pub. Date: Mar. 17, 2011

(54) Extinguishing Nozzle Body

(75) Inventor: Max Lakkonen, Rosrath (DE)

(73) Assignee: FOGTEC BRANDSCHUTZ GMBH & CO. KG, Köln (DE)

(21) Appl. No.: 12/990,529

(22) PCT Filed: Feb. 6, 2009
(86) PCT No.: PCT/EP09/51369

§ 371 Date: Dec. 2, 2010

(30) Foreign Application Priority Data
May 2, 2008 (DE) 10 2008 021 925.8

(51) Int. Cl. A62C 37/08

(52) U.S. Cl. 169/37

(57) ABSTRACT

For fire-fighting an extinguishing nozzle body 2 for spraying extinguishing fluid and a fire-fighting device are proposed. The extinguishing nozzle body is characterised by at least two spray nozzles 4 arranged along a periphery of the extinguishing nozzle body 2 and at least one deflector 8 arranged in the area of the spray jet 6 of the extinguishing fluid emerging from the spray nozzles 4. Effective fire-fighting is achieved in that a spray angle 10 of the spray jet relative to the lateral surface of the extinguishing nozzle body 2, a angle of attack 12 of the deflector 8 relative to the direction of the spray jet 6, a clearance 14 between the deflector 8 and the lateral surface of the extinguishing nozzle body 2 and a high pressure of the extinguishing fluid is set in such a way that a cone-shaped spray pattern ensues.

The subject matter relates to an extinguishing nozzle body for spraying extinguishing fluid with at least two spray nozzles arranged along a periphery of the extinguishing nozzle body. The subject matter also relates to a fire-fighting device with an extinguishing nozzle body.

In all areas open to the public, and in areas where safety is of high importance, fire-fighting is of particularly high importance. These days both sprinkler systems and water fog systems are used for fire-fighting. The use of water fog systems has the advantage that fire-fighting can take place with very small quantities of extinguishing fluid. Particularly because of the very good cooling properties of fluid fog, the area around the fire can be cooled effectively. In addition, the evaporation of the extinguishing fluid draws oxygen away from the source of the fire so that this is gradually suffocated.

Particularly in tunnels, fire-fighting is of ever increasing importance. Smoke gases must be prevented from spreading within the tunnel. The known extinguishing fog systems prevent the formation of smoke gases and at the same time use little fluid. Particularly in highly branched systems, the low fluid use is an advantage since the fluid reservoirs and the pipelines only have to be designed for lower volumes.

The distribution of the extinguishing fluid in the spray pattern has proven to be an essential parameter for the extinguishing properties. Depending on the application, either a directed spray pattern or an even distribution within the area is necessary. The spray pattern can be influenced by a suitable arrangement of the spray nozzles within the extinguishing nozzle body.

Since the spray pattern is of essential importance for successful fire-fighting, the subject matter is based on the object of providing an even, cone-shaped spray pattern with low effort in terms of production engineering.

This object is achieved by means of an extinguishing nozzle body, which has at least two spray nozzles arranged along a periphery of the extinguishing nozzle body, and at least one deflector arranged in the area of the spray jet of the extinguishing fluid emerging from the spray nozzles, wherein a spray angle of the spray jet relative to the lateral surface of the extinguishing nozzle body, an angle of attack of the deflector relative to the direction of the spray jet, a clearance between the deflector and the lateral surface of the extinguishing nozzle body and a pressure of the extinguishing fluid are set in such a way that a cone-shaped spray pattern ensues.

It has been found that through an appropriate choice of the spray angle of the spray jet, the angle of attack of the deflector and the pressure a cone-shaped spray pattern can be generated. Here a deflector can be arranged above the spray nozzles. A deflector can also be formed by an external surface. For example, an extinguishing nozzle body can be provided with extinguishing nozzles which spray in the direction of a wall. The wall can then constitute the deflector. A suitable alignment between the clearance from the wall and the impact angle allows the spray pattern to be set.

The spray angles can be such that the extinguishing fluid that emerges impinges upon the deflector surface shortly after emergence. For their part, the spray nozzles can be designed in such a way that when the extinguishing fluid emerges, very small droplets are formed. These can be 10 μm-500 μm in size, but preferably 30 μm-100 μm in size. Said droplet spectra can preferably form following the impacting of the spray stream on the deflector surface. These fluid droplets impinge upon the deflector surface with high kinetic energy and are deflected. Hereby a further splitting of the fluid droplets into even finer droplets can take place. In addition, through a suitable choice of the angle of attack of the deflector, the direction of the entire spray jet of the extinguishing fluid emerging from the spray nozzles can be varied. Depending on how far away the deflector is from the openings of the spray nozzles, another droplet distribution ensues in the spray pattern.

An extinguishing nozzle body can for example be an extinguishing nozzle head, which is screwed into a pipeline. It is also possible for the extinguishing nozzle body to be a pipe in which extinguishing nozzles have been introduced, e.g. by drilling or threading.

By suitable choice of the pressure, for example 30-300 bar, the droplet size and the angle of the cone-shaped spray pattern can be varied. A pressure of 6-30 bar, preferably more than 10 bar, is also possible. The higher the pressure, the higher the kinetic energy can be with which the fluid droplets impact the deflector surface. In this way both the rebound angle of the fluid droplets against the deflector surface and the droplet size after impacting the deflector surface can be set. Through a suitable choice of the high pressure, the spray pattern can be given a cone-shaped design, in particular a design which is evenly distributed in a cone shape.

According to an advantageous exemplary embodiment, it is proposed that the spray angle of the spray stream is 30°-90° in relation to the lateral surface of the extinguishing nozzle head. The openings in the spray nozzles can be arranged either pointing vertically from the extinguishing nozzle head or at an angle to the lateral surface of the extinguishing nozzle head. For example, it is possible to provide a V-shaped groove in the lateral surface, and to arrange the spray nozzles in one wall of the V-shaped groove. In this way the spray angle of the spray jet relative to the lateral surface of the extinguishing nozzle head can be set according to the angle of the V-shaped groove. Depending on which angle is set, a different cone-shaped spray pattern will result. For a large spray angle in particular, for example of around 90°, a particularly even cone-shaped spray pattern ensues.

According to a further advantageous exemplary embodiment it is proposed that the angle of attack of the deflector is 30°-60° in relation to the direction of the spray jet. The choice of angle of attack also determines the angle at which the fluid droplets impinge upon the deflector surface. In this way it is possible firstly to set the size of the fluid droplets after they impact on the deflector surface and secondly the overall aperture angle of the cone-shaped spray pattern.

The clearance between the deflector and the lateral surface of the spray head can, according to an advantageous exemplary embodiment, be 0.5-5 cm. The closer the deflector surface is arranged to the spray nozzle, the higher the impact energy of the fluid droplets will be on the deflector surface. The droplet spectrum of the spray pattern will vary according to the impact energy. In order to obtain the most uniform possible cone-shaped spray pattern, according to an advantageous exemplary embodiment it is proposed that the spray nozzles are arranged on the lateral surface of the spray nozzle head, in one plane at even angular distances from one another. Firstly the spray nozzles can be arranged in one plane. Irrespective of this, the spray nozzles can be arranged at the same angular distances from one another. By a suitable arrangement of the spray nozzles along the lateral surface, various spray patterns can ensue. If the spray nozzles are arranged at even angular distances from one another a very even, cone-shaped spray pattern results.

According to an advantageous embodiment it is proposed that the extinguishing nozzle head has a chamber arranged upstream of the extinguishing nozzles in the direction of flow of the extinguishing fluid. Extinguishing fluid can initially flow into this chamber. In the event of a fire, the extinguishing liquid flows out of the upstream chamber and in this way is evenly distributed among the spray nozzles.

In order to achieve a good distribution of the fluid droplets within the spatial volume surrounding the source of the fire, it is proposed that in the direction of flow of the extinguishing fluid behind the spray nozzles supplementary spray nozzles are arranged in the lateral surface of the extinguishing nozzle head. These supplementary spray nozzles can be arranged below the spray nozzles starting from the supply line to the extinguishing nozzle head. For example, the supplementary spray nozzles can be arranged in such a way that the spray jet emerging from these supplementary nozzles no longer impinges upon the deflector surface of the deflector. For example, the supplementary nozzles can be set up in such a way that they spray extinguishing fluid with a different droplet spectrum from the spray nozzles. The supplementary nozzles can also be set up in such a way that the spray stream emerging from them collides with the spray stream emerging from the spray nozzles and deflected by the deflector. Through this collision a better droplet distribution can be achieved.

In order to be able to vary the spray pattern of the supplementary nozzles, and to be able to set the spray angle of the supplementary nozzles, according to an advantageous exemplary embodiment it is proposed that the supplementary nozzles are arranged in a circumferential groove along the lateral surface of the extinguishing nozzle head.

A particularly evenly distributed spray pattern is achieved in that the supplementary nozzles are offset at angular distances from the spray nozzles. Here the supplementary spray nozzles spray in radial directions, which are not covered by the spray nozzles themselves. The radial spray directions of the supplementary spray nozzles, starting from the extinguishing nozzle head, can, according to this advantageous exemplary embodiment, be arranged offset from the radial spray direction of the spray nozzles.

The supplementary spray nozzles can also be arranged along a pipe or a hollow body in such a way that they are arranged in a direction in order to spray a wall, for example.

A fine distribution of the fluid drops is achieved in that the spray angles of the supplementary nozzles are such that the extinguishing fluid droplets of the extinguishing fluid emerging from the supplementary nozzles collide with the extinguishing fluid droplets emerging from the extinguishing nozzles and deflected by the deflector, or mix with these.

In order to bring about a collision between the fluid droplets emerging from the spray nozzles and the deflector, according to an advantageous exemplary embodiment it is proposed that the deflector has a deflector surface with its angle of attack pointing in the direction of the spray nozzles.

In order to bring about the deflection of, as far as possible, all the fluid droplets emerging from the spray nozzles, it is proposed that the deflector is arranged around the periphery of the extinguishing nozzle head.

In order to bring about the fastest possible emergence of extinguishing fluid at the corresponding extinguishing nozzle head in the event of a fire in the immediate vicinity of the extinguishing nozzle head, it is proposed that the extinguishing nozzle head has an integrated fire detection means. Such a fire detection means can for example be a glass bulb which bursts when the temperature rises. For example, the glass bulb can hold a spindle in a closed position. If the glass bulb bursts, the spindle is displaced into the open position, so that the extinguishing fluid can enter the chamber.

A further subject matter is a fire-fighting device with a high-pressure reservoir for extinguishing fluid and a pipeline connecting the high-pressure reservoir with at least one extinguishing nozzle head as described above.

In order to generate a fluid fog, it is proposed that the high-pressure reservoir has a working pressure of at least 100-150 bar. A pipe pressure in the pipeline can be 10-20 bar.

In the following the subject matter is explained in more detail by means of a drawing showing embodiments. The drawing shows as follows:

FIG. 1 an extinguishing nozzle head according to an advantageous embodiment;

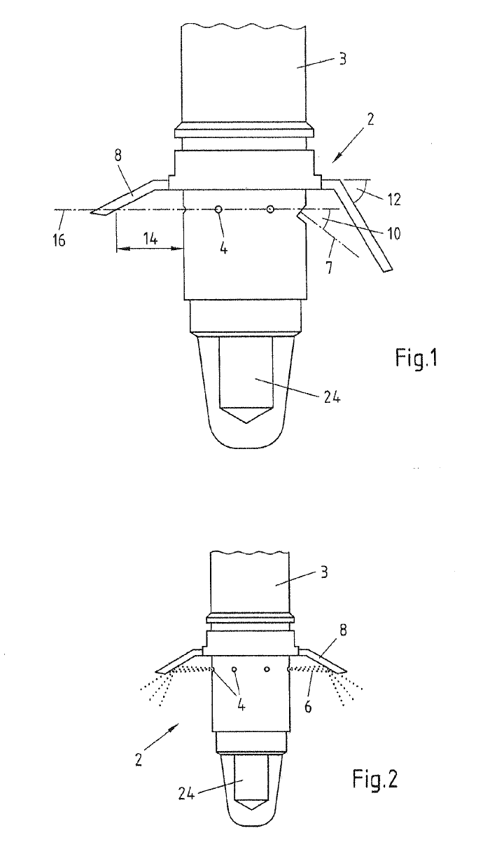

FIG. 2 an extinguishing nozzle head in the activated state;

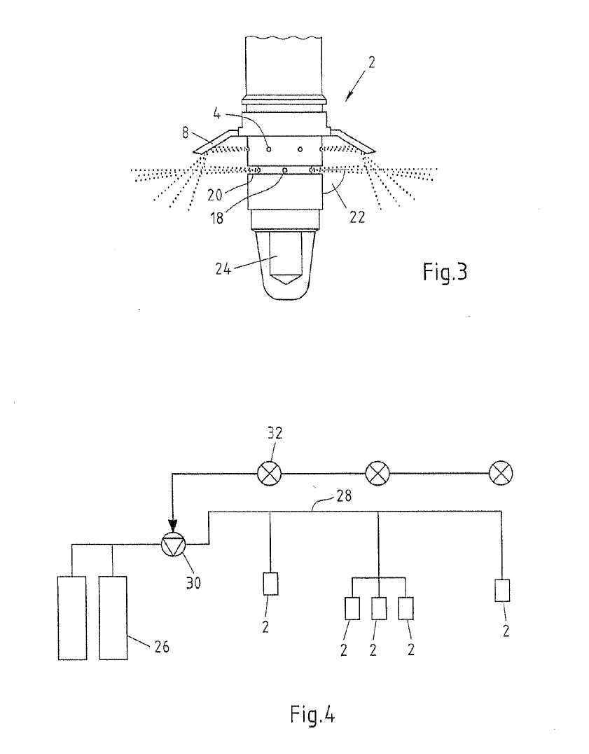

FIG. 3 an extinguishing nozzle head according to an advantageous embodiment in the activated state;

FIG. 4 a fire-fighting device.

FIG. 1 shows an extinguishing nozzle head 2 with a supply line 3, which can be connected to a pipeline. The extinguishing nozzle head 2 is for example screwed to the supply line 3.

FIG. 1 also shows spray nozzles 4, a deflector 8, a spray angle 10, an angle of attack 12 and a plane 16 along which the spray nozzles 4 are arranged. A clearance 14 between lateral surface of the extinguishing nozzle head 2 and the deflector surface of the deflector 8 is also shown.

It can be seen that the spray nozzles 4 are arranged at angular distances in the radial direction to the extinguishing nozzle head. The spray nozzles 4 can for example be provided as drill holes within the extinguishing nozzle head 2. It is also possible for the spray nozzles 4 to be arranged as nozzle inserts, for example with a screw-fit, in the extinguishing nozzle head 2.

The spray nozzles 4 can be arranged in such a way that a spray jet emerges in the direction 7 from the extinguishing nozzle head 2. The direction 7 is determined by the spray angle 10 of the spray jet. By a suitable choice of spray angle 10, an impact angle of the spray jet on the deflector surface of the deflector 8 can be defined.

The deflector 8 is arranged running around the periphery of the extinguishing nozzle head 2. The deflector surface of the deflector 8 is angled downwards with a clearance from the extinguishing nozzle head 2. The angle of attack 12 of the deflector surface, angled downwards, of the deflector 8 can be varied according to the requirements of the spray pattern of the extinguishing nozzle head 2. The length of the deflector surface pointing downwards can also be varied, as indicated by the differing lengths to the left and right of the central axis of the extinguishing nozzle head. It is also possible to vary the lengths of the deflector surfaces, which point downwards, along the periphery in such a way as to vary the projection of the spray pattern. For example, it is possible in some areas to design the deflector surface to be shorter and give it a different angle of attack than in other areas. The result of this is that the spray pattern can be varied according to the angles of attack.

In addition to this, the clearance 14 can be varied. The smaller the clearance 14 between spray nozzle 4 and deflector surface of the deflector 8, the higher the impact energy of the extinguishing fluid on the deflector surface. The level of the impact energy will determine the extent to which the droplets are split into finer droplets.

A glass bulb 24 is also shown that can serve as a fire detection means. The glass bulb 24 can be such that it bursts if a raised temperature prevails in the vicinity of the extinguishing nozzle head 2. Through the bursting of the glass bulb 2, a spindle (not shown) can be moved within the extinguishing nozzle head 2 in such a way that it allows a fluid communication between the supply line 3 and the spray nozzles 4. The extinguishing fluid can then be passed from the supply line 3 into the spray nozzles 4 and emerge as a spray jet.

In the extinguishing nozzle head 2 is a chamber (not shown) which branches off to the spray nozzles 4. By means of the chamber it is possible to enable an even admission flow of fluid to the spray nozzles 4.

FIG. 2 shows an extinguishing nozzle head 2 in the activated state. In the activated state the glass bulb 24 has burst, and extinguishing fluid enters the extinguishing nozzle head 2 via the supply line 3. Via the chamber the extinguishing fluid enters the spray nozzles 4 and emerges from the spray nozzles 4 as a spray jet 6. From FIG. 2 it can be seen that immediately after emerging from the spray nozzles 4 the spray stream 6 impinges upon the deflector surface of the deflector 8. This deflects the spray stream and directs it downwards. The fluid droplets present in the spray stream are broken up further by the impact and subsequently a finely distributed spray pattern results. This spray pattern is characterised by a cone-shaped, even fluid droplet distribution.

FIG. 3 shows a further exemplary embodiment of an extinguishing nozzle head 2. It can be seen that below the spray nozzles 4 a circumferential groove 20 is provided in the extinguishing nozzle head 2. In the circumferential groove 20 supplementary nozzles 18 are provided. The supplementary nozzles 18 point in the radial direction offset to the spray nozzles 4. The supplementary nozzles spray fluid droplets with a spray angle 22 away from the spray head 2. The size of the fluid droplets can be set by appropriate setting of the openings in the supplementary nozzles 8. In the activated state, that is to say after the glass bulb 24 has burst, extinguishing fluid flows both from the spray nozzles 4 and from the supplementary nozzles 18. As can be seen, the spray streams from the supplementary nozzles 18 and the spray streams from the extinguishing nozzles 4 deflected by the deflector 8 intersect in the vicinity of the extinguishing nozzle head 2. At the intersection of the spray streams, fluid droplets mix, leading to a further fog-like distribution of the extinguishing fluid.

FIG. 4 shows a fire-fighting system with a high-pressure fluid reservoir 26, an activation valve 30, a pipeline 28, fire detectors 32 and extinguishing nozzle heads 2 connected to the pipelines 28. As can be seen, the pipeline 28 branches off into various subdivisions, on which a differing number of extinguishing nozzle heads 2 can be arranged. The pipeline 28 can for example be arranged in a tunnel system. In a tunnel system the sub-branches can provide protection from fires for various areas of the tunnel by means of the extinguishing nozzle heads 2. In each area, for example, a fire detector 32 can be arranged. Activation of just individual areas is also possible by means of the fire detectors 32.

In the event of a fire, a fire is detected by a fire detector 32 and the activation valve 30 opened. Extinguishing fluid flows at high pressure, for example at 10-150 bar, from the high-pressure fluid container 26 into the pipeline 28 and then into the extinguishing nozzle heads 2. The extinguishing nozzle heads 2 spray the extinguishing fluid as a finely distributed fog with droplet sizes of 10-500 μm, preferably 30-100 μm. The droplet spectrum can vary according to the setting of the extinguishing nozzles 4 and the supplementary nozzles 18, and according to the arrangement of the spray angles of the extinguishing nozzles 4, the angle of attack of the deflector 8, the clearance between the deflector and the spray nozzles 4, the arrangement of the supplementary nozzles 18 and also the spray angle of the supplementary nozzles 18. Depending on the application, in different areas of the tunnel system, differing spray patterns may be necessary which can be set by means of suitable extinguishing nozzle heads 2.

By means of the extinguishing nozzle heads according to the subject matter, fire-fighting for various types of fires can be set up by varying the different parameters of the extinguishing nozzle head.

1-15. (canceled)

16. An extinguishing nozzle body for spraying extinguishing fluid comprising at least two spray nozzles arranged along the periphery of the nozzle body; and at least one deflector arranged in the area of a spray jet of extinguishing fluid emerging from the spray nozzles, wherein a spray angle of the spray jet relative to a lateral surface of the extinguishing nozzle body, an angle of attack of the deflector relative to the direction of the spray jet, a clearance between the deflector and the lateral surface of the extinguishing nozzle body and a pressure of the extinguishing fluid are set in such a way that an evenly distributed cone-shaped spray pattern of extinguishing fluid emerges.

17. The extinguishing nozzle body according to claim 1, wherein the spray angle of the spray jet is 30°-90° in relation to the lateral surface of the extinguishing nozzle body.

18. The extinguishing nozzle body according to claim 1 wherein the angle of attack of the deflector is 30°-60° in relation to the direction of the spray jet.

19. The extinguishing nozzle body according to claim 1 wherein clearance between the deflector and a lateral surface of a nozzle body spray head is 0.5-5 cm.

20. The extinguishing nozzle body according to claim 1, wherein the spray nozzles are arranged on the lateral surface of the extinguishing nozzle body in one plane at even angular spacings from one another.

21. The extinguishing nozzle body according to claim 1, wherein the extinguishing nozzle body has a chamber arranged upstream of the spray nozzles in the direction of flow of the extinguishing fluid.

22. The extinguishing nozzle body according to claim 1, wherein supplementary spray nozzles are arranged after the spray nozzles in the direction of flow of the extinguishing fluid in the lateral surface of the extinguishing nozzle body.

23. The extinguishing nozzle body according to claim 22, wherein the supplementary nozzles are arranged in a circumferential groove along the lateral surface of the extinguishing nozzle body.

24. The extinguishing nozzle body according to claim 22, wherein the supplementary nozzles are arranged at angles offset from the spray nozzles.

25. The extinguishing nozzle body according to claim 22, wherein the spray angles of the supplementary nozzles are such that the extinguishing fluid droplets of the extinguishing fluid emerging from the supplementary nozzles collide with the extinguishing fluid droplets emerging from the spray nozzles as deflected by the deflector.

26. The extinguishing nozzle body according to claim 1, wherein the deflector has a deflector surface with its angle of attack pointing in the direction of the spray nozzles.

27. The extinguishing nozzle body according to claim 1, wherein the deflector is arranged around the periphery of the extinguishing nozzle body.

28. The extinguishing nozzle body according to claim 1, wherein the extinguishing nozzle body has an integrated fire detection means.

29. A fire-fighting device with a high-pressure reservoir for extinguishing fluid and a pipeline connecting the high-pressure reservoir with at least one extinguishing nozzle body according to claim 1.

30. The fire-fighting device according to claim 29, wherein the high-pressure reservoir has a load pressure of at least 100 bar.
